(19) United States
(12) Patent Application Publication
(10) Pub. No.: US 2025/0157437 A1
(43) Pub. Date: May 15, 2025

(54) IMAGE PROCESSING USING HARDWARE PARAMETERS OF DISPLAY

(71) Applicant: Varjo Technologies Oy, Helsinki (FI)

(72) Inventors: Antti Hirvonen, Espoo (FI); Mikko Strandborg, Hangonkylä (FI)

(73) Assignee: Varjo Technologies Oy, Helsinki (FI)

(21) Appl. No.: 18/508,523

(22) Filed: Nov. 14, 2023

(51) Int. Cl. G09G 5/391; G06F 3/01; G06T 3/40

(52) U.S. Cl. CPC G09G 5/391; G06F 3/013; G06T 3/40; G09G 2340/0407

(57) ABSTRACT

Disclosed is a system with server(s) configured to: receive, from a display apparatus, hardware parameters of a display of the display apparatus and optical path information pertaining to an optical path between the display and a user's eye; determine an effective resolution for each point on the display, based at least on the hardware parameters of the display and the optical path information; determine a foveation setting to be employed for image processing; determine image processing setting(s) to be employed for image processing, based on the effective resolution for each point on the display and the foveation setting; process an image according to the image processing setting(s); and send the image to the display apparatus.

### TECHNICAL FIELD

The present disclosure relates to systems for image processing using hardware parameters of displays. The present disclosure also relates to methods for image processing using hardware parameters of displays.

### BACKGROUND

In recent times, there has been an ever-increasing demand for foveated image generation. Such a demand may, for example, be quite high and critical in case of evolving technologies such as immersive extended-reality (XR) technologies, which are being employed in various fields such as entertainment, real estate, training, medical imaging operations, simulators, navigation, and the like. Such immersive XR technologies create XR environments for presentation to users of XR devices (such as an XR headsets, pairs of XR glasses, or similar).

However, existing equipment and techniques for generating images have several problems associated therewith. The existing equipment and techniques employ a conventional foveation setting, wherein a resolution of an image is spatially modulated within a framebuffer. Such a modulation results in presenting a gaze region (which can be fixed or can dynamically change according to user's gaze) of the image at a full native resolution of the display, and as one moves away from this gaze region towards a periphery of the display, the resolution of the image gradually (or may be discretely) decreases. Such a spatial variation in the resolution typically follows a fixed pre-defined foveation curve. However, when the display and its corresponding optics are inherently incapable of reproducing very high visual detail, there is loss of computational resources that are utilised in generating such visual details. For example, when a user's eye deviates from a direct alignment with an optical axis of a display, and gazes slightly away from a centre of the display, a practical maximum resolution (in terms of pixels per degree (PPD)) at its periphery is diminished as compared to an ideal maximum PPD achievable along the optical axis. In other words, a level of detail perceivable from such an off-centre angle is lower than a theoretical expectation when the user gazes directly at the centre. This potentially results in high computational performance overhead, as image generation might operate at an excessively high PPD, causing extra computational workload without any significant benefits.

Therefore, in light of the foregoing discussion, there exists a need to overcome the aforementioned drawbacks.

### SUMMARY

The present disclosure seeks to provide a system and a method to generate high-quality and realistic images for a display apparatus according to image processing setting(s) in a computationally-efficient and a time-efficient manner. The aim of the present disclosure is achieved by a system and a method which incorporate image processing using hardware parameters of display, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of an architecture of a system for image processing using hardware parameters of display, in accordance with an embodiment of the present disclosure;

FIG. 2 illustrates steps of a method for image processing using hardware parameters of display, in accordance with an embodiment of the present disclosure;

FIG. 3 illustrates an exemplary scenario of viewing an image on a display of a display apparatus by a user's eye, in accordance with an embodiment of the present disclosure;

FIG. 4 illustrates an exemplary image that is processed according to an image processing setting, in accordance with an embodiment of the present disclosure; and

FIGS. 5A and 5B illustrate different graphical representations of a foveation map, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a system comprising at least one server configured to:
receive, from a display apparatus, hardware parameters of a display of the display apparatus and optical path information pertaining to an optical path between the display and a user's eye;
determine an effective resolution for each point on the display, based at least on the hardware parameters of the display and the optical path information;
determine a foveation setting to be employed for image processing;
determine at least one image processing setting to be employed for image processing, based on the effective resolution for each point on the display and the foveation setting;
process an image according to the at least one image processing setting; and
send the image to the display apparatus.

In a second aspect, an embodiment of the present disclosure provides a method comprising:
receiving, from a display apparatus, hardware parameters of a display of the display apparatus and optical path information pertaining to an optical path between the display and a user's eye;
determining an effective resolution for each point on the display, based at least on the hardware parameters of the display and the optical path information;
determining a foveation setting to be employed for image processing;
determining at least one image processing setting to be employed for image processing, based on the effective resolution for each point on the display and the foveation setting;
processing an image according to the at least one image processing setting; and
sending the image to the display apparatus.

The present disclosure provides the aforementioned system and the aforementioned method, for generating high-quality and realistic images in a computationally-efficient and a time-efficient manner, by way of employing image processing using hardware parameters of the display. Herein, the effective resolution for each point on the display is determined using the hardware parameters (that are indicative of an intrinsic capability of the display for presenting visual content) and the optical path information (that indicates how the light travels from the display to the user's eye). Then, depending on whether a foveated image is to be generated or a non-foveated image is to be generated, (image data corresponding to) the image is processed accordingly, using the at least one image processing setting. Beneficially, in this manner, the image is optimally (i.e., highly accurately and realistically) generated. Moreover, image generation in this manner does not rely on a fixed pre-defined foveation curve, and thus rendering/transport efficiency in the image generation process is also improved by using the hardware parameters. The system and the method are simple, robust, support real-time and reliable image processing, and can be implemented with ease.

Notably, the at least one server controls an overall operation of the system. The at least one server is communicably coupled to at least the display apparatus. The at least one server may be understood to be a compositor (namely, a processing unit configured to perform at least compositing tasks pertaining to processing/generating images). The compositor is a software module taking various inputs (such as at least the at least one image processing setting) and composing (namely, generating) said image(s) according to the at least one image processing setting (as discussed later). Upon processing, said image(s) is/are sent the display apparatus, for example, for displaying thereat.

In some implementations, the at least one server is implemented as a remote server. In an example, the remote server could be a cloud server that provides a cloud computing service, and could be arranged in a geographical location that is different from a geographical location of the display apparatus. In other implementations, the at least one server is implemented as a processor of a computing device that is communicably coupled to the display apparatus. Examples of the computing device include, but are not limited to, a laptop, a desktop, a tablet, a phablet, a personal digital assistant, a workstation, and a console. It will be appreciated that the term “at least one server” refers to “a single server” in some implementations, and to “a plurality of servers” in other implementations.

Throughout the present disclosure, the term “display apparatus” refers to specialized equipment that is capable of at least displaying images. These images may be presented to a user of the display apparatus. It will be appreciated that the term “display apparatus” encompasses a head-mounted display (HMD) device and optionally, a computing device communicably coupled to the HMD device. The term “head-mounted display” device refers to specialized equipment that is configured to present an extended-reality (XR) environment to the user when said HMD device, in operation, is worn by the user on his/her head. The HMD device is implemented, for example, as an XR headset, a pair of XR glasses, and the like, that is operable to display a visual scene of the XR environment to the user. The term “extended-reality” encompasses virtual reality (VR), augmented reality (AR), mixed reality (MR), and the like. The system could be integrated within the display apparatus (for example, within the HMD device), or could be remotely located from the display apparatus.

Throughout the present disclosure, the term “hardware parameter” of the display of the display apparatus refers to a physical attribute or characteristic associated with the display of the display apparatus. Herein, the term “display” refers to an element from which light emanates. The display of the display apparatus is driven to display image(s). Examples of the display include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display. The display could also be implemented as a projector. Displays and projectors are well-known in the art.

Optionally, the hardware parameters of the display comprise at least one of: a display resolution, an optical axis of the display, a size of the display, a pixel size of pixels of the display, a pixel layout of the pixels of the display, a pose of the display within the display apparatus. The term “display resolution” refers to a total number of pixels in each dimension of the display, or to a pixel density (namely, a number of pixels per unit distance or area) of the display. The term “optical axis” of the display refers to an imaginary line that defines a path along which the light propagates from the display towards the user's eyes (via some optics therebetween). Such an imaginary line is typically perpendicular to a centre of the display. The optical axis of the display is often coincident with a mechanical axis of the display. The term “size” of the display refers to a physical dimension of the display. The size of the display may be expressed in units of length such as inches, centimetres, and the like. The term “pixel size” of pixels of the display refers to a physical dimension of an individual pixel on the display. Lesser the pixel size of pixels in a given region of the display, higher is the pixel density in the given region and potentially, higher is the visual detail in said region, and vice versa. The pixel size may be expressed in units of length such as millimetres, microns, and the like. The term “pixel layout” of the pixels of the display refers to an arrangement of the pixels on the display i.e., how the pixels are arranged on the display. Such an arrangement could, for example, be a rectangular two-dimensional (2D) grid, a polygonal arrangement, a circular arrangement, an elliptical arrangement, a freeform arrangement, or the like. In an example, the display may comprise 2073600 pixels arranged in the rectangular 2D grid (such as a 1920×1080 pixel grid). The term “pose” of the display refers to a position and/or an orientation of the display within the display apparatus. For example, the display may be inclined at an angle of 30 degrees with respect to the centre of the display. All the aforementioned hardware parameters are well-known in the art. It will be appreciated that the hardware parameters of the display are pre-known to a processor of the display apparatus, as these parameters are determinable at a time of designing, manufacturing, and assembling the display (namely, could be obtained either from simulations or device-class specific measurements, or could be acquired in a factory calibration process). Utilisation of at least one of the aforementioned hardware parameters for determining the effective resolution will be discussed later.

Throughout the present disclosure, the term “optical path information” refers to data pertaining to the optical path between the display and the user's eye, when the display apparatus is in use. The term “optical path” refers to a trajectory that the light follows as it travels from the display towards the user's eye. It is to be understood that as the light travels from the display towards the user's eye, said light may pass through one or more optical elements that are arranged along the optical path between the display and the user's eye. Examples of the optical elements may include, but are not limited to, a lens, a mirror, a prism, a beam splitter, a polariser, a collimator, a waveguide, a diffractive element.

Optionally, the optical path information comprises at least one of: a length of the optical path, a relative arrangement of the optical path with respect to an optical axis of the display, information pertaining to optical elements arranged along the optical path. In this regard, the length of the optical path may vary depending on a design of the display apparatus, how the one or more optical elements are arranged along the optical path, and a position of the user's eye relative to the display. In a typical scenario, the length of the optical path could range from a few centimetres to several meters. In HMD devices, the optical path may be longer due to the use of several optical elements. Once the optical path is known, its arrangement (namely, alignment) with respect to the optical axis of the display can also be easily known. Further, optionally, the information pertaining to the optical elements arranged along the optical path comprises at least one of: a number of the optical elements, poses of the optical elements, optical properties of the optical elements. An optical property of a given optical element may include one or more of: a non-linear compression effect producible by the optical elements, a refractive index, a reflectance factor, a transmittance factor, a dispersion factor. The optical path information is well-known in the art. It will be appreciated that the optical path information is pre-known to the processor of the display apparatus, as it can be determinable at a time of designing, manufacturing, and assembling the display (namely, could be obtained either from simulations or device-class specific measurements, or could be acquired in a factory calibration process). Utilisation of at least one of the aforementioned factors in the optical path information for determining the effective resolution will be discussed later.

Further, since the hardware parameters are indicative of an intrinsic capability of the display for presenting visual content thereon, the effective resolution for each point can be determined by taking into account the hardware parameters. For example, greater the display resolution and smaller the pixel size, greater is the capability of the display to display high-quality visual content. Additionally, since the optical path information indicates how the light travels from the display to the user's eye (for example, upon interacting with the optical elements therebetween), the effective resolution for each point on the display can be accurately determined by the at least one server. This may depend on presence and arrangement of the one or more optical elements along the optical path between the display and the user's eye. For example, when the one or more optical elements (for example, such as distortive lenses) are arranged along the optical path between the display and the user's eye, and when the optical path is closely aligned with the optical axis of the display, an effective resolution for each point that is closer to the optical axis is higher, as compared to points that are located relatively far from the optical axis. This may be because distortion and aberrations in the light path are minimised when the optical path closely aligns with the optical axis, resulting in a higher effective resolution for points of the display closer to the optical axis, as compared to points farther from the optical axis, which may experience more distortion. However, the one or more optical elements are absent i.e., when the display is directly observed by the user's eye, the effective resolution may increase towards edges of the display.

Optionally, the at least one server is further configured to:
receive, from the display apparatus, information indicative of a gaze direction of the user's eye; and
determine a gaze rotation as an angular separation between an optical axis of the display and the gaze direction of the user's eye,
   wherein the effective resolution for each point on the display is determined based also on the gaze rotation.

Herein, the term “gaze direction” refers to a direction in which the user's eye is gazing. The gaze direction may be represented by a gaze vector. Optionally, (the processor of) the display apparatus is configured to: process gaze-tracking data, collected by gaze-tracking means, to determine the gaze direction of the user's eye; and send the information indicative of the gaze direction to the at least one server. Optionally, in this regard, the display apparatus comprises the gaze-tracking means.

The term “gaze-tracking means” refers to specialized equipment for detecting and/or following gaze of the user's eyes, when the display apparatus (for example, the HMD device) in operation is worn by the user. The gaze-tracking means could be implemented as contact lenses with sensors, cameras monitoring a position, a size and/or a shape of a pupil of a given eye of the user, and the like. The gaze-tracking means are well-known in the art. Determining the gaze direction of the user's eye facilitates in tracking where the user is looking/gazing. The gaze-tracking data may comprise images/videos of the user's eye, sensor values, and the like. Optionally, when processing the gaze-tracking data, (the processor of) the display apparatus is configured to employ at least one of: an image processing algorithm, a feature extraction algorithm, a data processing algorithm. Techniques/algorithms for processing the gaze-tracking data to determine the gaze direction are well-known in the art. It will be appreciated that the gaze-tracking data is collected repeatedly throughout a given session of using the display apparatus, as a gaze of the user's eye keeps changing whilst the display apparatus is in use. It will also be appreciated that the aforesaid information is obtained by the at least one server in real time or near-real time.

Optionally, the gaze direction is a current gaze direction. Alternatively, optionally, the gaze direction is a predicted gaze direction. It will be appreciated that optionally the predicted gaze direction is predicted, based on a change in user's gaze, wherein the predicted gaze direction lies along a direction of the change in the user's gaze. In such a case, the change in the user's gaze could be determined in terms of a gaze velocity and/or a gaze acceleration of a given eye of the user, using information indicative of previous gaze directions of the given eye and/or the current gaze direction of the given eye. Yet alternatively, optionally, the gaze direction is a default gaze direction, wherein the default gaze direction is straight towards a centre of a field of view of the user. In this regard, it is considered that the user's gaze is, by default, typically directed towards the centre of the field of view of said user. In such a case, a central region of the field of view of said user is resolved to a much greater degree of visual detail, as compared to a remaining, peripheral region of the field of view of said user.

Further, the term “gaze rotation” refers to an angular separation between the optical axis of the display and the gaze direction of the user's eye. As the user's gaze changes while using the display apparatus, the gaze direction of the user changes, and the gaze rotation also changes accordingly. It is to be understood that when the gaze direction coincides with the optical axis of the display (i.e., when a gaze location lies at a centre of the display), a value of the gaze rotation is zero. As the user's gaze (namely, the gaze location) moves away from the centre of the display, a value of the gaze rotation increases. The gaze rotation may, for example, be expressed in terms of degrees or radians.

It will be appreciated that since both the optical axis of the display and the gaze direction are accurately known to the at least one server, the gaze rotation could be easily calculated, for example, using a geometry-based formula. Alternatively, optionally, the at least one server is configured to utilise calibration data to determine the gaze rotation, wherein the calibration data comprises different values of the angular separation between the optical axis and different gaze directions of the user's eye, the optical axis of the display being always fixed. The calibration data could be collected during a calibration process, wherein at least one reference image representing one or more visual spots at one or more locations in said image, is presented to the user, and then corresponding gaze directions are determined to calculate corresponding values of the gaze rotation. A given visual spot would be distinctly visible in the at least one reference image. Optionally, the at least one server is configured to obtain the calibration data directly from the display apparatus. Alternatively, optionally, the at least one server is configured to obtain the calibration data from a data repository whereat the calibration data is pre-stored, the data repository being communicably coupled to the at least one server. The data repository could, for example, be implemented as a memory of the at least one server, a memory of the display apparatus, a memory of the computing device, a removable memory, a cloud-based database, or similar. Optionally, the system further comprises the data repository. Optionally, the at least one server is configured to receive the hardware parameters and the optical path information from the data repository, instead of the display apparatus. It will be appreciated that the data repository optionally stores hardware parameters and optical path information of several display apparatuses.

It will also be appreciated that typically, greater the value of the gaze rotation, lesser is the effective resolution for a given point on the display, and vice versa. This is because as the user's gaze moves away from the centre of the display, the value of the gaze rotation increases, as discussed earlier. Thus, the effective resolution for points that lies in a central portion of the display would be higher, as compared to points that lies away from the central portion of the display. The effective resolution gradually decreases for points on the display when going away from the central portion of the display towards a peripheral portion of the display. It is to be understood that a particular gaze direction would correspond to one or more points on the display.

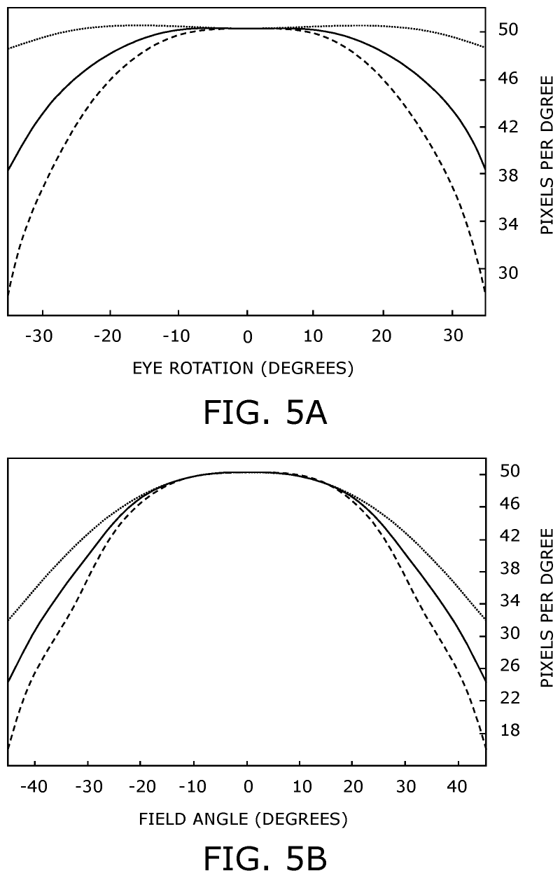

Optionally, the at least one server utilises at least one foveation map to determine the effective resolution for each point on the display based on the gaze rotation. Herein, the term “foveation map” refers to a data structure comprising information pertaining to how a resolution spatially varies across the image. Such a spatially-variable resolution from the foveation map can be easily utilised to determine the effective resolution, for cases when the user's eye lies at a centre of the display or rotates with respect to the centre. The at least one foveation map could, for example, be a graphical representation of the resolution (such as in terms of the PPD) as a function of the gaze rotation, or a graphical representation of the resolution as a function of an angular distance (i.e., a viewing angle) from a gaze location on the display. This has been also illustrated in conjunction with FIGS. 5A and 5B. Optionally, the at least one foveation map is pre-stored at the data repository.

Furthermore, a mapping of the gaze direction to the PPD is akin to a comprehensive map (i.e., the at least one foveation map) that takes into account an entire range of possible gaze directions. Instead of having separate foveation maps for horizontal and vertical gaze rotations, there can be a single foveation map also. Typically, the PPD could be a tangential PPD or a sagittal PPD. The tangential PPD is a resolution along a direction that is tangential to the optical axis of the display or a line of sight of the user. Thus, the tangential PPD is measured in a direction parallel to the plane of user's vision when the user is looking straight ahead. The tangential PPD is important when considering clarity and detail of objects or images that are not directly in a centre of a field of view of the user, but are located off to a side. Moreover, the sagittal PPD is a resolution along a direction perpendicular to the optical axis or the line of sight. The sagittal PPD is important when considering the clarity and detail of objects or images that are oriented vertically, or in a direction that is perpendicular to the line of sight.

It will be appreciated that since a value of the gaze rotation for a particular gaze direction is known (as discussed earlier), and the at least one foveation map is available to the at least one server, the effective resolution for one or more points on the display that correspond to the particular gaze direction can be easily and accurately determined. It will also be appreciated that the at least one foveation curve is be adjusted, based on a sensitivity of the human eye (that defines an upper limit of an effective resolution that a given point on the display should have, assuming an ideal optical set-up of the display apparatus), the hardware parameters and the optical path information (that collectively define an upper limit of an effective resolution that a given point on the display can actually have, considering limitations of an optical set-up of the display apparatus). The at least one foveation curve should be adjusted according to a minimum of the aforesaid upper limits of the effective resolution.

Throughout the present disclosure, the term “foveation setting” refers to a setting that indicates whether a foveated image is to be generated or a non-foveated image is to be generated. The foveated image is an image in which a resolution (for example, in terms of pixels per degree (PPD)) varies spatially across a field of view of the image. In other words, a given region of the image has a higher resolution, as compared to a remaining region of the image. The non-foveated image is an image in which a resolution does not vary (i.e., remains uniform) across a field of view of the image. A concept of foveation in image processing is well-known in the art. Depending on whether the foveated image is to be generated or the non-foveated image is to be generated, image data corresponding to the image would be processed accordingly. In some implementations, the foveation setting is indicative of the foveation being enabled. In other implementations, the foveation setting is indicative of the foveation being disabled. The foveation setting can either be system-defined or user-defined.

Notably, once the effective resolution and the foveation setting are known to the at least one server, the at least one image processing setting is determined accordingly. Throughout the present disclosure, the term “image processing setting” refers to a setting that indicates how image data corresponding to at least a region of an image is to be processed. It will be appreciated that the at least one image processing setting encompasses at least an image rendering setting (such as an image resolution setting and an image enhancement setting (that pertains to at least one of: deblurring, contrast enhancement, low-light enhancement, tone mapping, colour conversion, white balancing, super-resolution, and the like) as well as an image transport setting (such as an image downsampling setting). In an example, when the foveation setting is to generate the foveated image, a given region of the image is rendered at a higher resolution, as compared a remaining region of the image, and thus different image processing settings may be determined (and employed) to render these different regions of the image. Moreover, upon rendering, when the image is to be sent to the display apparatus, different regions (having different resolutions) in the image are sent using different image transport settings. The term “image transport setting” refers to a setting that indicates how an image is to be packed (by the at least one server) for transmitting it to the display apparatus.

Once the at least one image processing setting is determined, the image is processed (namely, image data corresponding to at least a region of the image is processed). Optionally, when processing the image, the at least one server is configured to employ at least one image processing algorithm. Image processing algorithms for processing the image are well-known in the art. It will be appreciated that processing the image would encompass at least rendering of the image and/or downsampling of the image. This will now be discussed hereinbelow in detail. Notably, upon processing the image, said image is sent to the display apparatus, for example, in real time or near time. Optionally, the processor of the display apparatus is configured to display the image at the display of the display apparatus.

In an embodiment, when the foveation setting is indicative of foveation being enabled, the at least one image processing setting is one of:
(i) a spatially-variable resolution is to be employed for rendering the image;
(ii) a spatially-variable resolution is to be employed for rendering the image, and spatially-uniform downsampling is to be employed for downsampling the image for transport;
(iii) a spatially-variable resolution is to be employed for rendering the image, and spatially-variable downsampling is to be employed for downsampling the image for transport;
(iv) a spatially-invariant resolution is to be employed for rendering the image, and spatially-variable downsampling is to be employed for downsampling the image for transport.

In this regard, when the foveation setting is indicative of foveation being enabled, all the aforementioned image processing settings would yield foveated images. In other words, when the foveation is “ON”, a given region of the image is rendered with a higher resolution, as compared to a remaining region. In an active foveation implementation, a location of the given region within the image may change dynamically, based on a user's gaze. Beneficially, an image quality of the rendered image emulates characteristics of a human visual system. In a fixed foveation implementation where the user's gaze is assumed to be directed straight towards a centre of the image, the given region is a central region within the image.

Optionally, when the at least one image processing setting is (i), this means that the at least one image processing setting comprises only a resolution setting to be employed for rendering the image, and no transport setting (for example, a downsampling setting) is employed for transporting/sending the image from the at least one server to the display apparatus. In this case, upon rendering, the image is sent to the display apparatus without any downsampling. Alternatively, optionally, when the at least one image processing setting is one of: (ii), (iii), (iv), the at least one image processing setting comprises both a resolution setting as well as a transport setting. In this case, upon rendering, a downsampled image is sent to the display apparatus.

It will be appreciated that when the spatially-variable resolution is optionally employed for rendering the image, the image is generated (by the at least one server) in a manner that a resolution of the image varies spatially across a field of view of said image (i.e., different regions of the image would have different resolutions). Such a spatial variation of resolution could be determined based on effective resolutions for all points on the display. A resolution for a given region of the image could, for example, be equal to an average effective resolution of a corresponding region in the display.

Further, optionally, when the spatially-uniform downsampling is employed for downsampling the image, the image is downsampled (namely, compressed) by the at least one server in a manner that a downsampling ratio (namely, a compression ratio) is uniform (i.e., does not change) across a field of view of said image. This means that an entirety of the image (i.e., each region of the image) is downsampled using a same downsampling ratio. The term “downsampling ratio” refers to a measure of relative reduction in a size of an image that is obtained by employing a downsampling technique to said image. As an example, a downsampling ratio of 2:1 means that a size of a downsampled image is half of a size of the (original) image. As another example, a downsampling ratio of 1:1 means that a size of a downsampled image is same as a size of the (original) image. The downsampling ratio and downsampling techniques are well-known in the art. It will be appreciated that upon receiving a downsampled image, a processor of the display apparatus is configured to upsample (namely, decompress) the downsampled image (for example, using an upsampling technique), prior to displaying the image at the display of the display apparatus. Upsampling techniques are well-known in the art.

Alternatively, when the spatially-variable downsampling is optionally employed for downsampling the image, the image is downsampled in a manner that different regions of said image are downsampled using different downsampling ratios. Greater the downsampling ratio for a given region of the image, greater is the extent of compression of the given region for the transport, and lesser is the amount of data to be transmitted from the at least one server to the display apparatus, and vice versa. As an example, for a first region (that corresponds to the user's gaze) and a second region (that surrounds the first region) of the image, a higher downsampling ratio is employed for the second region as compared to the first region. Alternatively, in this example, the first region may not be downsampled at all (i.e., a downsampling ratio for the first region is 1:1), and only the second region may be downsampled using a downsampling ratio of N:1, where N being greater than 1. It will be appreciated that employing the different downsampling ratios potentially facilitates in improving an image quality of the image, whilst enabling efficient reduction of data to be transferred between the at least one server and the display apparatus, with lesser transmission resources (such as bandwidth requirement). In this case, the at least one server implements gaze-directed downsampling.

It will also be appreciated that when the spatially-invariant resolution is optionally employed for rendering the image, the image is generated (by the at least one server) in a manner that an entirety of the image has a same/uniform resolution throughout its field of view. Such a uniform resolution may be equal to a maximum effective resolution from amongst effective resolutions for all points on the display. However, optionally, when the at least one image processing setting is (iv), this means that the image is rendered at a uniform resolution, but then that same image is further processed (for transportation purposes) by employing the spatially-variable downsampling in a manner different regions of the image are downsampled using the different compression ratios, and thus would eventually have different resolutions, despite being rendered at a uniform resolution.

Optionally, when the image is processed according to the at least one image processing setting, the image comprises at least a first region having a first resolution and a second region having a second resolution, the first resolution being greater than the second resolution, and wherein the at least one server is further configured to utilize framebuffer bandwidth by performing at least one of:
decrease the first resolution to a third resolution and increase the second resolution to a fourth resolution, the third resolution being greater than the fourth resolution;
increase a size of an area of the display to which a first portion of at least one framebuffer is mapped, wherein the first region is stored in the first portion of the at least one framebuffer.

In this regard, the first region may be understood to be a region of interest of the user's gaze, whereas the second region may be understood to be a remaining region of the image that surrounds the region of interest. However, the image may further comprise other region(s) in addition to the first region and the second region, the other region(s) having different resolution(s). For example, the image may further comprise a third region (namely, an intermediate region) between the first region and the second region, the third region having a third resolution that is greater than the second resolution, but is lesser than the first resolution.

The term “framebuffer bandwidth” refers to a rate at which data can be accessed from or stored at a given framebuffer. Optionally, the given framebuffer is a portion of a memory associated with the at least one server. Framebuffers are well-known in the art. Typically, the given framebuffer stores framebuffer data corresponding to at least a region of the given image. Optionally, in this regard, framebuffer data corresponding to the first region and framebuffer data corresponding to the second region are stored in separate framebuffers. Alternatively, optionally, framebuffer data corresponding to both the first region and the second region are stored in a same shared framebuffer. Optionally, the framebuffer data comprises at least one of: colour data, depth data, luminance data, opacity data, corresponding to a given region of the image. Framebuffer data and its generation are well-known in the art.

It will be appreciated that, decreasing the first resolution to the third resolution facilitates in saving the framebuffer bandwidth, and thus the framebuffer bandwidth that is saved could be beneficially utilised for increasing the third resolution, without any additional framebuffer bandwidth requirement. This would still maintain foveation in the generated image, as the first region would still have a higher resolution as compared to the second region (because the third resolution is greater than the fourth resolution). Optionally, when decreasing the first resolution to the third resolution, the at least one server is configured to employ a downsampling technique, whereas when increasing the second resolution to the fourth resolution, the at least one server is configured to employ an upsampling technique.

Further, in another case, optionally, framebuffer data corresponding to the first region (that is stored in the first portion of the at least one framebuffer) is used for rendering the first region of the image in a manner that upon said rendering, the first region is displayed at an increased area of the display at the first resolution only. It will be appreciated that since the first region may correspond to the region of interest, increasing (namely, enlarging) the size of the area of the display to which the first portion is mapped allows for an improved visual quality in the region of interest. Moreover, sending the image (upon its generation) may involve sending the framebuffer data from the first portion of the at least one framebuffer to the display. For managing the framebuffer bandwidth in an efficient manner, the at least one server may prioritise the first region and may allocate a greater part of the framebuffer bandwidth to the first region, and then could allocate remaining part of the framebuffer bandwidth for sending the second region to the display. This potentially minimizes an overall time and processing resource utilisation required to transfer the entirety of the image to the display. As a result, the first region, representing the user's primary focus, is displayed with exceptional clarity in real time or near-real time, thereby enhancing a user's viewing experience.

In another embodiment, when the foveation setting is indicative of foveation being disabled, the at least one image processing setting is that a spatially-invariant resolution is to be employed for rendering the image, said resolution being equal to a maximum effective resolution amongst effective resolutions for all points on the display. In this regard, when the foveation setting is indicative of foveation being disabled, the aforementioned image processing setting would yield non-foveated images. In other words, when the foveation is “OFF”, the image is rendered at a uniform resolution throughout its field of view. The uniform resolution could be easily determined as the maximum effective resolution since the effective resolutions for all the points on the display could be known to the at least one server from the at least one foveation map (as discussed earlier).

The present disclosure also relates to the method as described above. Various embodiments and variants disclosed above, with respect to the aforementioned first aspect, apply mutatis mutandis to the method.

Optionally, the method further comprises:
receiving, from the display apparatus, information indicative of a gaze direction of the user's eye; and
determining a gaze rotation as an angular separation between an optical axis of the display and the gaze direction of the user's eye,
   wherein the effective resolution for each point on the display is determined based also on the gaze rotation.

Optionally, in the method, the hardware parameters of the display comprise at least one of: a display resolution, an optical axis of the display, a size of the display, a pixel size of pixels of the display, a pixel layout of the pixels of the display, a pose of the display within the display apparatus.

Optionally, in the method, the optical path information comprises at least one of: a length of the optical path, a relative arrangement of the optical path with respect to an optical axis of the display, information pertaining to optical elements arranged along the optical path.

In an embodiment, in the method when the foveation setting is indicative of foveation being enabled, the at least one image processing setting is one of:
(i) a spatially-variable resolution is to be employed for rendering the image;
(ii) a spatially-variable resolution is to be employed for rendering the image, and spatially-uniform downsampling is to be employed for downsampling the image for transport;
(iii) a spatially-variable resolution is to be employed for rendering the image, and spatially-variable downsampling is to be employed for downsampling the image for transport;
(iv) a spatially-invariant resolution is to be employed for rendering the image, and spatially-variable downsampling is to be employed for downsampling the image for transport.

Optionally, when the image is processed according to the at least one image processing setting, the image comprises at least a first region having a first resolution and a second region having a second resolution, the first resolution being greater than the second resolution, the method further comprises utilizing framebuffer bandwidth by performing at least one of:
decreasing the first resolution to a third resolution and increasing the second resolution to a fourth resolution, the third resolution being greater than the fourth resolution;
increasing a size of an area of the display to which a first portion of at least one framebuffer is mapped, wherein the first region is stored in the first portion of the at least one framebuffer.

In an alternative embodiment, in the method, when the foveation setting is indicative of foveation being disabled, the at least one image processing setting is that a spatially-invariant resolution is to be employed for rendering the image, said resolution being equal to a maximum effective resolution amongst effective resolutions for all points on the display.

### DETAILED DESCRIPTION OF THE DRAWINGS

Referring to FIG. 1, illustrated is a block diagram of an architecture of a system 100 for image processing using hardware parameters of display, in accordance with an embodiment of the present disclosure. The system 100 comprises at least one server (for example, depicted as a server 102). Optionally, the system 100 further comprises a data repository 104 that is communicably coupled to the server 102. The server 102 is communicably coupled to a display apparatus 106. Optionally, the display apparatus 106 comprises a display 108.

It may be understood by a person skilled in the art that FIG. 1 includes a simplified architecture of the system 100, for sake of clarity, which should not unduly limit the scope of the claims herein. It is to be understood that the specific implementation of the system 100 is provided as an example and is not to be construed as limiting it to specific numbers or types of servers, data repositories, display apparatuses, and displays. The person skilled in the art will recognize many variations, alternatives, and modifications of embodiments of the present disclosure.

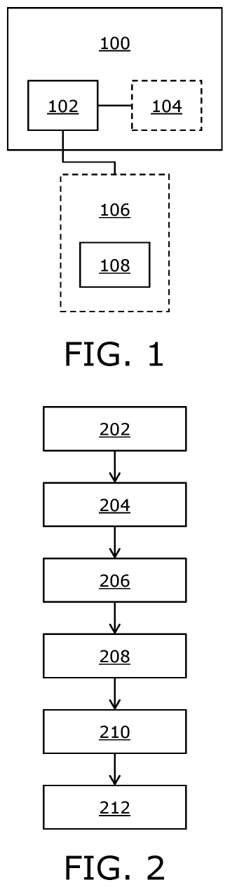

Referring to FIG. 2, illustrated are steps of a method for image processing using hardware parameters of display, in accordance with an embodiment of the present disclosure. At step 202, hardware parameters of a display of the display apparatus and optical path information pertaining to an optical path between the display and a user's eye, are received from a display apparatus. At step 204, an effective resolution for each point on the display is determined, based at least on the hardware parameters of the display and the optical path information. At step 206, a foveation setting to be employed for image processing is determined. At step 208, at least one image processing setting to be employed for image processing is determined, based on the effective resolution for each point on the display and the foveation setting. At step 210, an image is processed according to the at least one image processing setting. At step 212, the image is sent to the display apparatus.

The aforementioned steps are only illustrative and other alternatives can also be provided where one or more steps are added, one or more steps are removed, or one or more steps are provided in a different sequence without departing from the scope of the claims.

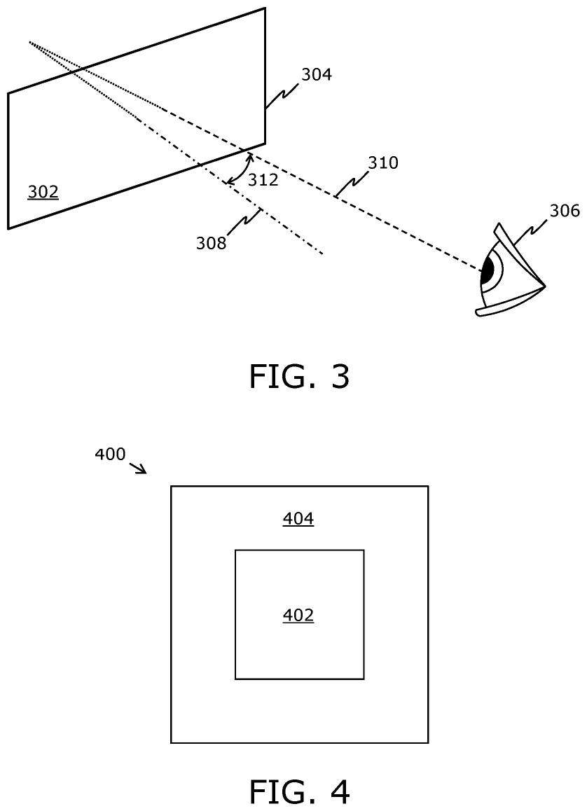

Referring to FIG. 3, illustrated is an exemplary scenario of viewing an image 302 on a display 304 of a display apparatus (not shown) by a user's eye 306, in accordance with an embodiment of the present disclosure. An optical axis 308 (for example, depicted using a dash-dot line) of the display 304 passes through a centre of the display 304. A gaze direction 310 (for example, depicted using a dashed line) of the user's eye 306 is shown to be not coinciding with the optical axis 308, and lies at a distance from the centre of the display 304. As shown, a gaze rotation is determined as an angular separation 312 between the gaze direction 310 and the optical axis 308.

Referring to FIG. 4, illustrated is an exemplary image 400 that is processed according to an image processing setting, in accordance with an embodiment of the present disclosure. Herein, a spatially-variable resolution setting is employed as the image processing setting, for rendering the image 400. In other words, a resolution of the image 400 varies spatially across a field of view of the image 400. Therefore, as shown, the image 400 comprises a first region 402 and a second region 404. The first region 402 has a first resolution, and the second region 404 has a second resolution, wherein the first resolution is greater than the second resolution. The first region 402 and the second region 404 may be determined, based on a gaze direction of a user (for example, at a centre of a display of a display apparatus). Thus, the first region 402 and the second region 404 may be understood to be a gaze region and a peripheral region of the image 400, respectively.

Referring to FIGS. 5A and 5B, illustrated are different graphical representations of a foveation map, in accordance with an embodiment of the present disclosure. With reference to FIG. 5A, the foveation map represents a variation of a resolution of an image as a function of a gaze rotation, the gaze rotation being an angular separation between an optical axis of a display of a display apparatus and a gaze direction of a user's eye. The resolution is shown along a vertical axis, in terms of pixels per degree. The eye rotation is shown along a horizontal axis, in terms of degrees. With reference to FIG. 5B, the foveation map represents a variation of a resolution of an image as a function of an angular distance (i.e., a viewing angle) from a gaze location on the display. The resolution is shown along a vertical axis, in terms of pixels per degree. The angular width (namely, a field angle) is shown along a horizontal axis, in terms of degrees. With reference to FIGS. 5A and 5B, a variation for three types of resolution is shown. A variation for a tangential resolution of the image is depicted using a dashed-line curve. A variation for a sagittal resolution of the image is depicted using a dotted-line curve. A variation for an average resolution of the image is depicted using a solid-line curve. With reference to FIG. 5A, the tangential resolution, the sagittal resolution, and the average resolution are maximum when the eye rotation is approximately within 10 degrees (in any direction) from a centre of the display, and then gradually decrease with an increase in the eye rotation. With reference to FIG. 5B, the tangential resolution, the sagittal resolution, and the average resolution are maximum when the field angle is approximately within 20 degrees, and then gradually decrease with an increase in the field angle.

FIGS. 3, 4, 5A, and 5B are merely examples, which should not unduly limit the scope of the claims herein. A person skilled in the art will recognize many variations, alternatives, and modifications of embodiments of the present disclosure.

1. A system comprising at least one server configured to:
receive, from a display apparatus, hardware parameters of a display of the display apparatus and optical path information pertaining to an optical path between the display and a user's eye;
determine an effective resolution for each point on the display, based at least on the hardware parameters of the display and the optical path information;
determine a foveation setting to be employed for image processing;
determine at least one image processing setting to be employed for image processing, based on the effective resolution for each point on the display and the foveation setting;
process an image according to the at least one image processing setting; and
send the image to the display apparatus.

2. The system of claim 1, wherein the at least one server is further configured to:
receive, from the display apparatus, information indicative of a gaze direction of the user's eye; and
determine a gaze rotation as an angular separation between an optical axis of the display and the gaze direction of the user's eye,
wherein the effective resolution for each point on the display is determined based also on the gaze rotation.

3. The system of claim 2, wherein the at least one server utilises at least one foveation map to determine the effective resolution for each point on the display based on the gaze rotation.

4. The system of claim 1, wherein the hardware parameters of the display comprise at least one of: a display resolution, an optical axis of the display, a size of the display, a pixel size of pixels of the display, a pixel layout of the pixels of the display, a pose of the display within the display apparatus.

5. The system of claim 1, wherein the optical path information comprises at least one of: a length of the optical path, a relative arrangement of the optical path with respect to an optical axis of the display, information pertaining to optical elements arranged along the optical path.

6. The system of claim 1, wherein when the foveation setting is indicative of foveation being enabled, the at least one image processing setting is one of:
(i) a spatially-variable resolution is to be employed for rendering the image;
(ii) a spatially-variable resolution is to be employed for rendering the image, and spatially-uniform downsampling is to be employed for downsampling the image for transport;
(iii) a spatially-variable resolution is to be employed for rendering the image, and spatially-variable downsampling is to be employed for downsampling the image for transport;
(iv) a spatially-invariant resolution is to be employed for rendering the image, and spatially-variable downsampling is to be employed for downsampling the image for transport.

7. The system of claim 6, wherein when the image is processed according to the at least one image processing setting, the image comprises at least a first region having a first resolution and a second region having a second resolution, the first resolution being greater than the second resolution, and wherein the at least one server is further configured to utilize framebuffer bandwidth by performing at least one of:
decrease the first resolution to a third resolution and increase the second resolution to a fourth resolution, the third resolution being greater than the fourth resolution;
increase a size of an area of the display to which a first portion of at least one framebuffer is mapped, wherein the first region is stored in the first portion of the at least one framebuffer.

8. The system of claim 1, wherein when the foveation setting is indicative of foveation being disabled, the at least one image processing setting is that a spatially-invariant resolution is to be employed for rendering the image, said resolution being equal to a maximum effective resolution amongst effective resolutions for all points on the display.

9. A method comprising:
receiving, from a display apparatus, hardware parameters of a display of the display apparatus and optical path information pertaining to an optical path between the display and a user's eye;
determining an effective resolution for each point on the display, based at least on the hardware parameters of the display and the optical path information;
determining a foveation setting to be employed for image processing;
determining at least one image processing setting to be employed for image processing, based on the effective resolution for each point on the display and the foveation setting;
processing an image according to the at least one image processing setting; and
sending the image to the display apparatus.

10. The method of claim 9, further comprising:
receiving, from the display apparatus, information indicative of a gaze direction of the user's eye; and
determining a gaze rotation as an angular separation between an optical axis of the display and the gaze direction of the user's eye,
wherein the effective resolution for each point on the display is determined based also on the gaze rotation.

11. The method of claim 9- or 10, wherein the hardware parameters of the display comprise at least one of: a display resolution, an optical axis of the display, a size of the display, a pixel size of pixels of the display, a pixel layout of the pixels of the display, a pose of the display within the display apparatus.

12. The method of claim 9, wherein the optical path information comprises at least one of: a length of the optical path, a relative arrangement of the optical path with respect to an optical axis of the display, information pertaining to optical elements arranged along the optical path.

13. The method of claim 9, wherein when the foveation setting is indicative of foveation being enabled, the at least one image processing setting is one of:
(i) a spatially-variable resolution is to be employed for rendering the image;
(ii) a spatially-variable resolution is to be employed for rendering the image, and spatially-uniform downsampling is to be employed for downsampling the image for transport;
(iii) a spatially-variable resolution is to be employed for rendering the image, and spatially-variable downsampling is to be employed for downsampling the image for transport;
(iv) a spatially-invariant resolution is to be employed for rendering the image, and spatially-variable downsampling is to be employed for downsampling the image for transport.

14. The method of claim 13, wherein when the image is processed according to the at least one image processing setting, the image comprises at least a first region having a first resolution and a second region having a second resolution, the first resolution being greater than the second resolution, the method further comprises utilizing framebuffer bandwidth by performing at least one of:
decreasing the first resolution to a third resolution and increasing the second resolution to a fourth resolution, the third resolution being greater than the fourth resolution;
increasing a size of an area of the display to which a first portion of at least one framebuffer is mapped, wherein the first region is stored in the first portion of the at least one framebuffer.

15. The method of claim 9, wherein when the foveation setting is indicative of foveation being disabled, the at least one image processing setting is that a spatially-invariant resolution is to be employed for rendering the image, said resolution being equal to a maximum effective resolution amongst effective resolutions for all points on the display.
